(19) United States
(12) Patent Application Publication
(10) Pub. No.: US 2006/0075259 A1
(43) Pub. Date: Apr. 6, 2006

(54) Method and system to generate a session key for a trusted channel within a computer system

(76) Inventors: Sundeep M. Bajikar, Santa Clara, CA (US); Francis X. McKeen, Portland, OR (US); Kelan Silvester, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/977,158

(22) Filed: Oct. 29, 2004

Related U.S. Application Data
(60) Provisional application No. 60/616,302, filed on Oct. 5, 2004.

(51) Int. Cl. G06F 12/14

(52) U.S. Cl. 713/189

(57) ABSTRACT

A method and system to exchange a private encryption key via a rusted path between a device and an application executed in a trusted platform of a computer system to generate a session key. In one embodiment, the session key is used to encrypt data to be exchanged via an non-trusted channel within the computer system.

### CROSS-REFERENCE TO RELATED APPLICATION

The present application claims priority to a provisional application filed on Oct. 5, 2004, and assigned Ser. No. 60/616,302, which is incorporated herein by reference.

### FIELD OF INVENTION

The field of invention relates generally to trusted computer platforms; and, more specifically, to a method and apparatus to generate a session key for a trusted channel within a computer system.

### BACKGROUND

Trusted operating systems (OS) and platforms are a relatively new concept. In first generation platforms, a trusted environment is created where applications can run trustedly and tamper-free. The security is created through changes in the processor, chipset, and software to create an environment that cannot be seen by other applications (memory regions are protected) and cannot be tampered with (code execution flow cannot be altered). As a result, the computer system cannot be illegally accessed by anyone or compromised by viruses.

In today's computing age, Subscripber Identify Modules (SIM), sometimes referred to as a smart card, are becoming more prevalent. A SIM is typically used for Global System for Mobile communications (GSM) phones to store telephone account information and provide Authentication, Authorization and Accounting (AAA). The SIM cards also allow a user to use a borrowed or rented GSM phone as if it were their own. SIM cards can also be programmed to display custom menus on the phone's readout. In some cases, the SIM cards include a built-in microprocessor and memory that may be used in some cases for identification or financial transactions. When inserted into a reader, the SIM is accessible to transfer data to and from the SIM.

When using a SIM card in a computer system, there is a need to securely access information from the SIM card in order to prevent accesses to the SIM from unauthorized software applications. Such accesses may be intended to learn certain SIM secrets or to break GSM authentication mechanisms and steal services provided.

### FIGURES

One or more embodiments are illustrated by way of example, and not limitation, in the Figures of the accompanying drawings, in which

FIG. 1 illustrates a computer system capable of providing a trusted platform to protect selected applications and data from unauthorized access, according to one embodiment;

FIG. 2 is a flow diagram describing a process of generating a session key, according to one embodiment;

FIG. 3 is a diagram further describing the process of mutual authentication, and the generation of the session key, in accordance with one embodiment

FIG. 4 is a flow diagram describing a process of providing a trusted channel within a computer system for a device, according to one embodiment.

### DETAILED DESCRIPTION

A method and system to exchange a private encryption key via a trusted path between a device and an application executed in a trusted platform of a computer system to generate a session key. In one embodiment, the session key is used to encrypt data to be exchanged via an non-trusted channel within the computer system.

In the following description, numerous specific details are set forth. However, it is understood that embodiments may be practiced without these specific details. In other instances, well-known circuits, structures and techniques have not been shown in detail in order not to obscure the understanding of this description.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. In addition, as described herein, a trusted platform, components, units, or subunits thereof, are interchangeably referenced as a protected or secured.

Trusted Platform

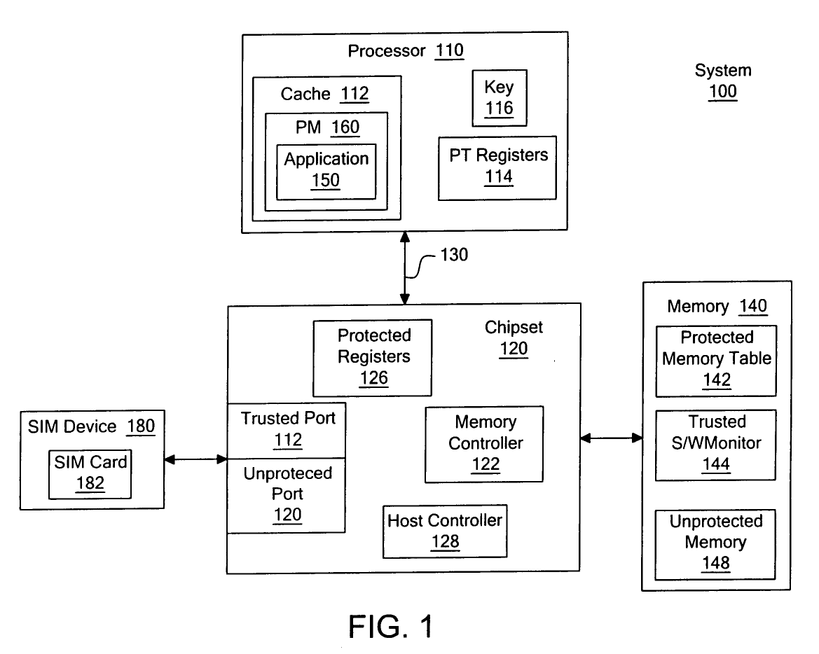

FIG. 1 illustrates a computer system, according to one embodiment, capable of providing a trusted platform to protect selected applications and data from unauthorized access. System 100 of the illustrated embodiment includes a processors 110, a chipset 120 connected to processors 110 via processor bus 130, a memory 140, and a SIM device 180 to access data on a SIM card 182. In alternative embodiments, additional processors and units may be included.

Processor 110 may have various elements, which may include but are not limited to, embedded key 116, page table (PT) registers 114 and cache memory (cache) 112. All or part of cache 112 may include, or be convertible to, private memory (PM) 160. Private memory is a memory with sufficient protections to prevent access to it by any unauthorized device (e.g., any device other than the associated processor 110) while activated as a private memory.

Key 116 may be an embedded key to be used for encryption, decryption, and/or validation of various blocks of data and/or code Alternatively, the key 116 may be provided on an alternative unit within system 100. PT registers 114 may be a table in the form of registers to identify which memory pages are to be accessible only by trusted code and which memory pages are not to be so protected.

In one embodiment, the memory 140 may include system memory for system 100, and in one embodiment may be implemented as volatile memory commonly referred to as random access memory (RAM). In one embodiment, the memory 140 may contain a protected memory table 142, which defines which memory blocks (where a memory block is a range of contiguously addressable memory locations) in memory 140 are to be inaccessible to direct memory access (DMA) transfers. Since all accesses to memory 140 go through chipset 120, chipset 120 may check protected memory table 142 before permitting any DMA transfer to take place. In a particular operation, the memory blocks protected from DMA transfers by protected memory table 142 may be the same memory blocks restricted to protected processing by PT registers 144 in processor 110. The protected memory table 142 may alternatively be stored in a memory device of an alternative unit within system 100.

In one embodiment, Memory 140 also includes trusted software (S/W) monitor 144, which may monitor and control the overall trusted operating environment once the trusted operating environment has been established. In one embodiment, the trusted S/W monitor 144 may be located in memory blocks that are protected from DMA transfers by the protected memory table 142.

Chipset 120 may be a logic circuit to provide an interface between processors 110, memory 140, SIM device 180, and other devices not shown. In one embodiment, chipset 120 is implemented as one or more individual integrated circuits, but in other embodiments, chipset 120 may be implemented as a portion of a larger integrated circuit. Chipset 120 may include memory controller 122 to control accesses to memory 140. In addition, in one embodiment, the chipset 120 may have a SIM reader of the SIM device integrated on the chipset 120.

In one embodiment, protected registers 126 are writable only by commands that may only be initiated by trusted microcode in processors 110. Trusted microcode is microcode whose execution may only be initiated by authorized instruction(s) and/or by hardware that is not controllable by unauthorized devices. In one embodiment, trusted registers 126 hold data that identifies the locations of, and/or controls access to, trusted memory table 142 and trusted SAN monitor 144. In one embodiment, trusted registers 126 include a register to enable or disable the use of trusted memory table 142 so that the DMA protections may be activated before entering a trusted operating environment and deactivated after leaving the trusted operating environment.

Process To Generate Session Key

As described herein, one embodiment provides a process to generate a session key for encrypted communications between a device, such as a SIM Card (or Smart Card, or SIM Reader), and an application executed in a trusted platform, such as a SIM Access Module (SAM). In one embodiment a Session Key Exchange Algorithm (SKEA) is run at both the device and the application to generate a session key at both the device and the application in a way that is resistant to the Man-In-Middle attacks. In one embodiment as described herein, the “device” is referenced as a SIM device and the application in the trusted platform is referenced as a “SAM.” In alternative embodiments, the processes described herein are applicable to devices other than a SIM device, and to applications other than SIM Access Modules.

In one embodiment, the SKEA does not require a public key certificates. Rather, in one embodiment, a private data is used. For example, in one embodiment, a random stream of characters is used as a long-term shared secret (LTSS) by the SKEA.

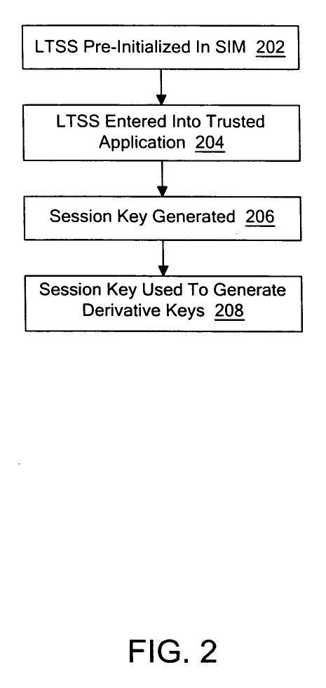

FIG. 2 describes the process of using an LTSS by the SKEA, in accordance with one embodiment. In process 202, in one embodiment, the LTSS is pre-initialized in the device hardware, possibly by the vendor. For example, in one embodiment, the LTSS may be printed on a sticker placed on a SIM device, included in a hand-out that accompanies a SIM device, or accessed on-line. In one embodiment, the LTSS is 160-bit, 32 characters based 32 encoded. An alternative form of the LTSS may be used.

In process 204, an end user accesses the LTSS and enters the LTSS into a trusted application of the SAM, via a trusted input. In one embodiment, the end user may manually enter the LTSS into a trusted application. As a result of entering the LTSS into the trusted application via a trusted input, there is a reduced chance of the malicious software running on the system snooping, stealing, or tampering with the LTSS. In an alternative embodiment, the LTSS may be provisioned by a wireless operator using an alternative technique that does not involve a user the system. Removing the user from the LTSS initialization loop may help to prevent attacks from malicious users.

In process 206, the device and the application in the trusted platform may proceed to carry out the SKEA to generate a session key. In one embodiment, the session key is referred to as the TLS Master Secret.

In process 208, the session key is used to generate a derivative set of keys to be used in encrypting data to be transmitted between the device and the application in the trusted platform. In one embodiment, the TLS Master Secret is supplied to the TLS Record Protocol to generate a derivative set of keys to be used in an APDU-TLS per-packet protocol between the device and applicaiton. See RFC 2246—Transport Layer Security (TLS).

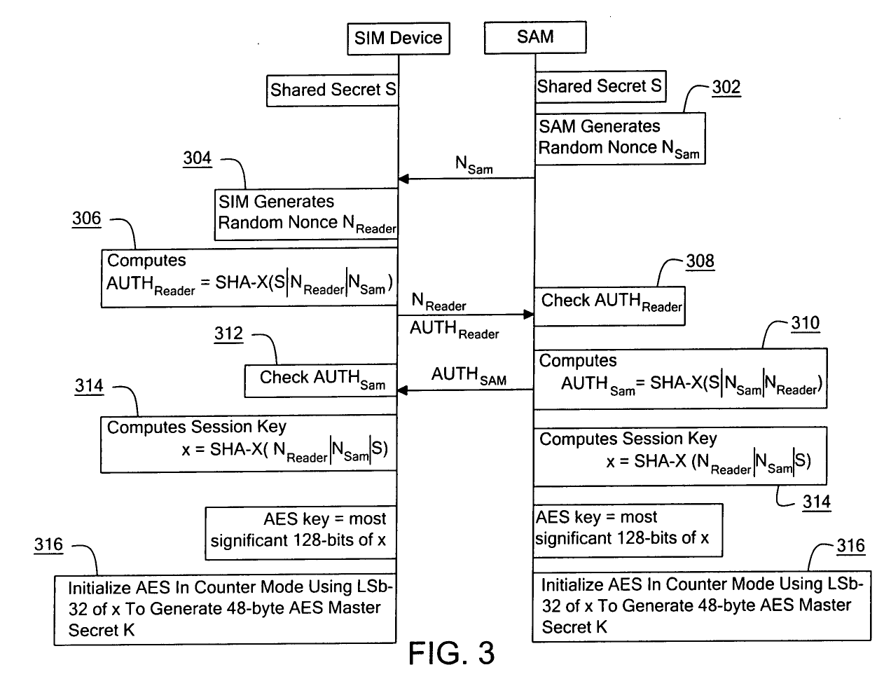

FIG. 3 provides a flow diagram further describing the process of the mutual authentication between the device and the application in the trusted platform, and the generation of the session key (referred to herein as the Master Secret,) in accordance with one embodiment. In one embodiment as described herein, the “device” is referenced as a SIM device and the application in the trusted platform is referenced as a “SAM.” In alternative embodiments, the processes described herein are applicable to devices other than a SIM device, and to applications other than SIM Access Modules.

In process 302, a software client residing in the SAM generates a random nonce (N_{SAM}) and transmits the N_{SAM} to the SIM device. In one embodiment, the N_{SAM} is 160-bit. In process 304, the SIM device generates a random nonce N_{reader}. In one embodiment, the N_{reader} is 160-bit. In process 306, the SIM device generates AUTH_{READER}=SHA-X(SI N_{reader}I N_{SAM}). The SIM device transmits the AUTH_{READER} and N_{reader} to the SAM. (As described herein, SHA-X is used to generically represent different variations of the SHA algorithm, e.g. SHA-1, SHAd-256, etc.)

In process 308, the SAM reads the AUTH_{READER} to authenticate the SIM device. In process 310, the SAM computes AUTH_{SAM}=SHA-X(SI N_{SAM}I N_{READER}) and transmits the AUTH_{SAM} to the SIM device. In process 310, the SIM device reads the AUTH_{SAM} to authenticate the SAM, and complete the mutual authentication.

In process 312, to compute the session key (K), both the SAM and the SIM device compute x=SHA-X(N_{reader}I N_{SAM}iS), and in one embodiment, use the most significant 128 bits of x as an Advance Encryption Standard (AES) key. In process 314, both the SAM and the SIM device then initialize AES in counter mode, using the least significant 32 bits of x as the initial counter value (after padding to make total length 128 bits), and 48 bytes are generated for use as the TLS master secret K.

Thereafter, in one embodiment, conventional TLS client/server session key derivation is used. In alternative embodiments, alternative forms of the nonces, authentication tokens, and protocols may be used.

Trusted Channel with SIM Device Example

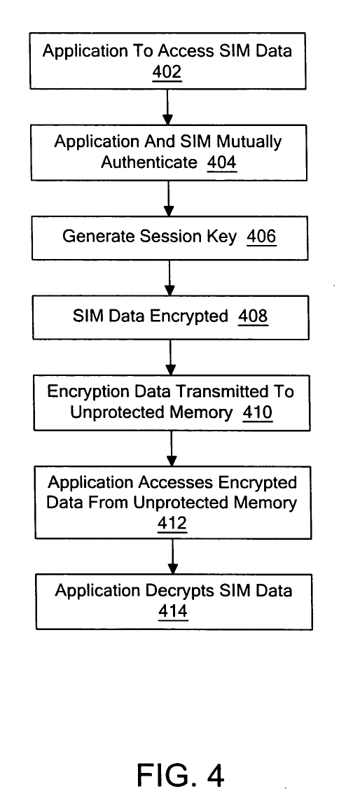

FIG. 4 is a flow diagram describing a process of providing a trusted channel within a computer system for a SIM device, according to one embodiment. As described herein, reference to a SIM device includes other types of related Smart cards. The processes described in the flow diagram of FIG. 4, are described with reference to the system of FIG. 1, described above.

In one embodiment, in process 402, an application 150 being executed in a trusted environment of the system 100, determines information is to be accessed from a SIM device 180 of the system 100. The application 150 being executed in a trusted atmosphere can be located in a protected memory, such as protected memory 160 of cache 112, or a protected section of memory 140. In one embodiment, the SIM device 180 includes a mechanism to ascertain that the accesses are coming from the application in a trusted environment that is running on the same platform that the SIM device is physically attached to, and not from some remotely executing application.

In process 404, the application and the SIM device perform a mutual authentication to determine that the SIM device is the correct device from which the application is to receive data, or that the application is the correct application to which the SIM device is to send the data.

In process 406, the SIM device 180 and application use a LTSS to generate a session key, as is described in more detail with reference to the flow diagram of FIG. 2.

In process 408, the SIM device 180 uses the session key to encrypt data to be sent to the SAM 150. In process 410, the encrypted packets are transferred from the SIM device 180 by a host controller 128 (e.g., a USB host controller) of the chipset to a regular area of memory (i.e., unprotected section of memory 148). For example, an area of memory that is used to store data packets, such as USB data packets.

In one embodiment, the encrypted packets are transmitted to the memory by the host controller via a regular port 120 of the chipset (i.e., an unprotected port), which maps to an unprotected section of memory 148. In one embodiment, the encrypted packets from the SIM device include Message Authentication Code (MAC) to provide a level of integrity protection.

In process 412, a driver (e.g., an unprotected USB driver) accesses the encrypted packets from the unprotected section of memory 148 and provides the encrypted packets to the application 150 being executed in the trusted environment. In process 416, the application 150 decrypts the encrypted packets to access the data from the SIM device, which have been securely transferred to the application via an non-trusted path within the system 100.

In one embodiment, new session keys may be generated based on predetermined events. For example, a new session key may be generated following one of, or a combination of, each new transaction (as defined based on implementation choice), the passage of a predetermined period of time, or the exchange of a predetermined amount of data.

In another alternative embodiment, multiple session keys are exchanged between the application 150 and the SIM device 180, to be used encrypted data exchanges between the SIM device 180 and the application 150. For example, a SIM device may include multiple data pipes (e.g., bulk-in, bulk-out, and default control pipes). For each of the data pipes of the SIM device, a separate session key may be used to protect the data exchanges. Alternatively, the separate data pipes may all use the same session key.

In an alternative embodiment, the data packets may be transmitted from the SIM device to the application without the use of encryption. For example, the host controller 128 transmits the data from the SIM device to the protected section of memory 140 via the trusted port 112 of the chipset 120. A trusted driver would then access the data from the protected section of memory 140 and provide the data to the application 150 via a trusted path, without having the SIM data encrypted.

The processes described above can be stored in the memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. In particular, as described herein, the SIM device is inclusive of Smart card devices, including USB Chip/Smart Card Interface Devices (CCID. Furthermore, the architecture of the system as described herein is independent of any particular key exchange protocols that are used. The specification and drawings are, accordingly, to be regarded in an illustrative rather than a restrictive sense.

1) A method comprising:
transmitting a private data between a device and an application executed in a trusted platform of a computer system, to generate a session key to encrypt data to be transmitted between the device and the application.

2) The method of claim 1, further including transmitting encrypted data between the device and the application via a non-trusted path within the computer system.

3) The method of claim 1, wherein the private data is pre-initialized in the device.

4) The method of claim 3, wherein the private data is accessible to an end-user.

5) The method of claim 3, wherein the private data is provided by a vendor of the device.

6) The method of claim 3, wherein the private data is entered into the application by an end-user prior to the transmitting of the private data.

7) The method of claim 1, wherein the private data is provided via a wireless operator.

8) The method of claim 4, wherein the private data is a Long Term Shared Secret (LTSS).

9) The method of claim 1, wherein the private data is a random stream of characters.

10) The method of claim 1, further including after transmitting the private data and generating the session key, using the session key to generate derivatives to encrypt data to be transmitted between the device and the application.

11) A system comprising:
a means for transmitting a private data between a device and an application executed in a trusted platform of a computer system, to generate a session key to encrypt data to be transmitted between the device and the application.

12) The system of claim 11, wherein the private data is pre-initialized in the device.

13) The system of claim 11, wherein the private data is accessible to an end-user.

14) The system of claim 11, further including means for entering the private data into the application by an end-user prior to the transmitting of the private data.

15) A machine readable medium having stored thereon a set of instructions, which when executed, perform a method comprising:
transmitting a private data between a device and an application executed in a trusted platform of a computer system, to generate a session key to encrypt data to be transmitted between the device and the application.

16) The machine readable medium of claim 15, wherein the private data is pre-initialized in the device.

17) The machine readable medium of claim 15, wherein the private data is accessible to an end-user.

18) The machine readable medium of claim 15, wherein the private data is entered into the application by an end-user prior to the transmitting of the private encryption key.

19) A system comprising:
A processor;
a unit to transmit a private data between a device and an application executed in a trusted platform of the system, to generate a session key to encrypt data to be transmitteded between the device and the application; and
a network interface.

20) The system of claim 19, wherein the private data is pre-initialized in the device.

21) The system of claim 19, wherein the private data is accessible to an end-user.

22) The system of claim 19, further including a unit to enter the private data into the application by an end-user prior to the transmitting of the private data.

23) The system of claim 19, wherein the device is a SIM device.

24) The system of claim 19, wherein the unit includes a machine readable medium having stored thereon a set of instructions, which when executed is to exchange the private data between the device and the application.

25) The system of claim 19, wherein the trusted platform of the system includes a private memory to prevent unauthorized access.
